(19) United States
(12) Patent Application Publication
(10) Pub. No.: US 2026/0301484 A1
(43) Pub. Date: Oct. 1, 2026

(54) METHODS AND SYSTEMS FOR STREAMING AUTONOMOUS VEHICLE LOG DATA

(71) Applicant: Stack AV Co., Mount Pleasant, PA (US)

(72) Inventors: Michael William DEASY, Pittsburgh, PA (US); Emin Ugur BOZKAYA, New York, NY (US); Rohith KASHYAP, Fremont, CA (US); Hwuiwon KIM, Jersey City, NJ (US); Kevin ALLEN, Pittsburgh, PA (US)

(73) Assignee: Stack AV Co., Mount Pleasant, PA (US)

(21) Appl. No.: 19/090,122

(22) Filed: Mar. 25, 2025

(51) Int. Cl. G07C 5/08; G07C 5/00

(52) U.S. Cl. CPC G07C 5/0825; G07C 5/008

(57) ABSTRACT

A method for streaming log data of an autonomous vehicle for visualization is provided. The method comprises receiving log data for an event associated with operation of the autonomous vehicle and generating a primary data file comprising groupings of the log data, wherein each grouping corresponds to a data type and each grouping is divided into segments associated with predefined time intervals. The method further comprises generating a metadata file for the event comprising timestamps and data locations corresponding to segment start or end points, and receiving a request specifying at least one data type and at least one temporal parameter. The method further comprises retrieving portions of the log data from the primary data file based on the request, timestamps, and data locations, and transmitting the portions of the log data to a data visualization platform to generate a visualization based on the specified data types.

### FIELD

The present disclosure relates generally to autonomous vehicle log data visualization and specifically to log data streaming.

### BACKGROUND

Visualization of autonomous vehicle log data may involve retrieving and interpreting large amounts log data. Data retrieval systems according to known techniques may rely on file formats that organize chunks of autonomous vehicle message data by time rather than by data type. As a result, individual chunks of data may contain multiple different data types, leading to data retrieval inefficiencies when a visualization involves a limited number of data types. For example, visualizing a particular data type, such as optical sensor frames, may involve downloading entire chunks of data that may include many unrelated data types, such as radar signals or vehicle diagnostics, due to the mixed nature of the file format.

Such chunk-based organization combined with data compression limitations may result in retrieval of much more information than is needed for a particular visualization. These inefficiencies may be compounded when data is stored in cloud-based environments, where retrieval bandwidth may be limited, in turn limiting the rate at which data can be retrieved or streamed to replay a set of log data. Known techniques may involve creation and maintenance of multiple versions of the same log data, such as full logs for detailed debugging and more limited logs for triaging. Such an approach may increase data storage requirements and/or introduce the risk of inconsistencies developing between the different versions.

### SUMMARY

Disclosed herein are methods and systems for streaming autonomous vehicle log data that address inefficiencies in known techniques for log data retrieval and streaming. As discussed above, organizing log data primarily by time rather than data type can lead to inefficiencies when visualizing a limited number of data types. These inefficiencies may result from retrieval of data chunks that often include unrelated data types, leading to the downloading and processing of additional data. Methods disclosed herein may introduce a streaming system operating near the file storage system, for example in the same cloud-based environment as the storage system. An exemplary streaming system may process autonomous vehicle log data, generating a primary data file and an associated metadata file. The primary data file may be grouped by data type. Each data type grouping may be further divided into data segments corresponding to predefined time intervals. The metadata file may include indices to map specified data types and time ranges to precise data locations or byte ranges in the data type groupings of the primary data file. Generation of primary data files stratified by data type and metadata files including indices may enable selective retrieval of log data portions relevant to a visualization based on user-specified data types and temporal parameters.

Such user-specified information may originate from a streaming system user interface and/or directly from a data visualization platform. For example, a user may specify an event corresponding to an autonomous vehicle activity (e.g. navigating an intersection during a test drive) or a particular time period associated with operation of the autonomous vehicle. A user may further specify one or more data types and/or one or more temporal parameters, for example one or more time ranges, of interest for a visualization. Alternatively or additionally, the user may, within the data visualization platform select a particular visualization panel and/or data indication affordance associated with a data type and/or time range, for example a LiDAR log data replay panel. Irrespective of whether the user request is made by specifying data types and/or temporal parameters within the user interface or the data visualization platform, the specified information may enable the streaming service to retrieve only the relevant portions of the log data, streaming those relevant portions of the log data to the visualization platform.

This approach may reduce over-fetching of log data and bandwidth usage, and may improve log replay loading and/or buffering time. For example, the streaming service may operate within the same environment as the file storage system, for example within a cloud-based storage environment. An exemplary streaming system may retrieve only data relevant to a visualization, thereby reducing bandwidth usage and allowing a log data file containing a large dataset or extended recording period to be partially streamed in an efficient manner to the data visualization platform. Furthermore, disclosed methods may obviate the generation of multiple versions of log files configured for different use cases, as an exemplary streaming system may accommodate the retrieval and provision of many combinations of different data types and/or temporal parameters.

In some embodiments, a method for streaming log data of an autonomous vehicle for visualization is provided, the method comprising: receiving autonomous vehicle log data for an event associated with operation of the autonomous vehicle; generating a primary data file for the event comprising one or more groupings of the autonomous vehicle log data, wherein each grouping of the one or more groupings corresponds to a particular data type of one or more data types of autonomous vehicle log data and each grouping of the one or more groupings is divided into one or more segments associated with one or more predefined time intervals; generating a metadata file for the event comprising one or more timestamps and one or more data locations, wherein each timestamp and data location corresponds to a start point or an end point of one of the one or more segments in the primary data file; receiving a request specifying: at least one data type of the one or more data types of autonomous vehicle log data to be streamed; and at least one temporal parameter, wherein the at least one temporal parameter corresponds to at least one grouping of the one or more groupings in the primary data file; retrieving one or more portions of the autonomous vehicle log data from the primary data file based on the request, the one or more timestamps in the metadata file, and the one or more data locations in the metadata file; and transmitting via a network communication interface the one or more portions of the autonomous vehicle log data to a data visualization platform to generate a visualization based on the specified data types of the one or more data types of autonomous vehicle log data.

In some embodiments, the event corresponds to an activity and a time period associated with operation of the autonomous vehicle. In some embodiments, the method further comprises storing the primary data file and metadata file in a hierarchical data structure, the hierarchical data structure corresponding to a unique identifier for the event. In some embodiments, the metadata file further comprises one or more schema definitions indicating a data format of the one or more data types of autonomous vehicle log data in the primary data file. In some embodiments, the one or more data locations specify the byte location corresponding to a start point or an end point of one of the one or more segments in the primary data file. In some embodiments, the method further comprises providing a user interface comprising one or more input affordances for selecting the event from a list comprising one or more events. In some embodiments, the method further comprises providing a user interface comprising one or more input affordances for selecting, from a list comprising the one or more data types, the at least one data type of the one or more data types of autonomous vehicle log data corresponding to the event. In some embodiments, the metadata file further comprises an indication of the one or more data types of autonomous vehicle log data in the primary data file, and the list comprising the one or more data types is generated for display in the user interface based on the metadata file. In some embodiments, the request is based on the selection, within the user interface, of the at least one data type of the one or more data types of autonomous vehicle log data. In some embodiments, the request is based on a user selection, within the data visualization platform, of at least one visualization display type corresponding to the at least one data type of the one or more data types of autonomous vehicle log data. In some embodiments, the request is based on a user selection, via a visualization display within the data visualization platform, of at least one playback position corresponding to the at least one temporal parameter. In some embodiments, the at least one temporal parameter is based on a user selection, via a visualization display within the data visualization platform, of a play button. In some embodiments, the at least one temporal parameter comprises a first temporal range and a second temporal range, the first temporal range and the second temporal range each comprise at least one time interval of the one or more predefined time intervals, and the first temporal range is immediately adjacent to the second temporal range. In some embodiments, retrieving the one or more portions of the autonomous vehicle log data comprises retrieving a first portion based on the first temporal range and retrieving a second portion based on the second temporal range, and transmitting the one or more portions of the autonomous vehicle log data comprises transmitting the first portion before transmitting the second portion. In some embodiments, the at least one temporal parameter comprises a first temporal range and a second temporal range, the first temporal range and the second temporal range each comprise at least one time interval of the one or more predefined time intervals, and the first temporal range and the second temporal range are separated from one another by one or more other temporal ranges. In some embodiments, the at least one temporal parameter comprises a temporal range extending from a start point of the event to an end point of the event, and retrieving the portion of the autonomous vehicle log data comprises retrieving all segments within the temporal range of the at least one grouping of the one or more groupings in the primary data file. In some embodiments, generating the visualization within the data visualization platform based on the specified data types of the one or more data types of autonomous vehicle log data comprises updating the visualization as additional portions of the autonomous vehicle log data are transmitted to the data visualization platform. In some embodiments, the primary data file and the metadata file are generated, and the one or more portions of the autonomous vehicle log data are retrieved, in a cloud computing environment at which the autonomous vehicle log data was received. In some embodiments, the visualization is generated in a computing environment separate from the cloud computing environment.

In some embodiments, a system for streaming log data of an autonomous vehicle for visualization is provided, the system comprising one or more processors and memory storing instructions that, when executed by the one or more processors, cause the system to: receive autonomous vehicle log data for an event associated with operation of the autonomous vehicle; generate a primary data file for the event comprising one or more groupings of the autonomous vehicle log data, wherein each grouping of the one or more groupings corresponds to a particular data type of one or more data types of autonomous vehicle log data and each grouping of the one or more groupings is divided into one or more segments associated with one or more predefined time intervals; generate a metadata file for the event comprising one or more timestamps and one or more data locations, wherein each timestamp and data location corresponds to a start point or an end point of one of the one or more segments in the primary data file; receive a request specifying: at least one data type of the one or more data types of autonomous vehicle log data to be streamed; and at least one temporal parameter, wherein the at least one temporal parameter corresponds to at least one grouping of the one or more groupings in the primary data file; retrieve one or more portions of the autonomous vehicle log data from the primary data file based on the request, the one or more timestamps in the metadata file, and the one or more data locations in the metadata file; and transmit via a network communication interface the one or more portions of the autonomous vehicle log data to a data visualization platform to generate a visualization based on the specified data types of the one or more data types of autonomous vehicle log data.

In some embodiments, a non-transitory computer readable storage medium storing instructions for streaming log data of an autonomous vehicle for visualization is provided, wherein the instructions, when executed by one or more processors of an electronic device, cause the device to: receive autonomous vehicle log data for an event associated with operation of the autonomous vehicle; generate a primary data file for the event comprising one or more groupings of the autonomous vehicle log data, wherein each grouping of the one or more groupings corresponds to a particular data type of one or more data types of autonomous vehicle log data and each grouping of the one or more groupings is divided into one or more segments associated with one or more predefined time intervals; generate a metadata file for the event comprising one or more timestamps and one or more data locations, wherein each timestamp and data location corresponds to a start point or an end point of one of the one or more segments in the primary data file; receive a request specifying: at least one data type of the one or more data types of autonomous vehicle log data to be streamed; and at least one temporal parameter, wherein the at least one temporal parameter corresponds to at least one grouping of the one or more groupings in the primary data file; retrieve one or more portions of the autonomous vehicle log data from the primary data file based on the request, the one or more timestamps in the metadata file, and the one or more data locations in the metadata file; and transmit via a network communication interface the one or more portions of the autonomous vehicle log data to a data visualization platform to generate a visualization based on the specified data types of the one or more data types of autonomous vehicle log data.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1A depicts an exemplary system for streaming log data of an autonomous vehicle for visualization, according to some embodiments.

FIG. 1B depicts an exemplary process for streaming log data of an autonomous vehicle for visualization, according to some embodiments.

FIG. 2A depicts an exemplary data file and metadata file of log data of an autonomous vehicle, according to some embodiments.

FIG. 2B depicts an exemplary file structure of log data of an autonomous vehicle, according to some embodiments.

FIG. 3A depicts an exemplary user interface to select data types and/or temporal parameters for visualization, according to some embodiments.

FIG. 3B depicts an exemplary visualization platform interface, according to some embodiments.

FIG. 4 depicts an exemplary workflow for streaming log data of an autonomous vehicle for visualization, according to some embodiments.

FIG. 5 depicts an exemplary computing system, according to some embodiments.

### DETAILED DESCRIPTION

Disclosed herein are methods and systems for streaming autonomous vehicle log data for visualization, facilitating efficient retrieval and presentation of data. Disclosed methods may address limitations of known techniques, which may involve inefficient retrieval of large log files or unnecessary data types, resulting in higher bandwidth usage and longer analysis times. Systems disclosed herein may operate near the file storage backend, enabling efficient data retrieval and transmission. By preprocessing log data into segments indexed using metadata, disclosed methods provide an ability for retrieving only data relevant for a user-defined visualization. By offloading data preprocessing to the file storage backend, disclosed methods may reduce data transfer costs and bandwidth consumption. Further, in contrast to known techniques that may place higher computational demands on a local system, disclosed methods may allow the platform to focus on data visualization thereby reducing analysis time.

An exemplary method may begin with the generation of log data from an autonomous vehicle during an event, for example a defined period of operation, testing, and/or simulation. This log data may include multiple data types, such as LiDAR point clouds, radar signals, optical sensor images, and/or system state messages. Known techniques often store this data in self-contained file formats organized temporally, requiring entire chunks of data to be retrieved even when only a subset of data types is relevant to a specific visualization. In contrast, the methods and systems disclosed herein may generate a primary data file and an associated metadata file based on the log data received from the autonomous vehicle. The primary data file may comprise groupings of autonomous vehicle log data, where each grouping may be organized temporally and correspond to a specific data type, such as LiDAR point clouds, radar signals, optical sensor images, and/or vehicle system state messages. The metadata file may provide indices linking specific data types and time ranges to precise byte ranges within the primary data file.

This file structure may enable an exemplary system to retrieve only relevant portions of the log data, for example only relevant portions of a primary data file, avoiding over-fetching and improving data transfer efficiency. By leveraging the mapping provided by each metadata file, an exemplary system may extract and transmit only requested portions of the primary data file rather than entire log chunks. As discussed below, an exemplary streaming system may operate near the file storage backend, allowing extraction and transmission of only relevant portions of log data.

User specifications of data for visualization may be made through a user interface of an exemplary streaming system and/or directly through a data visualization platform communicatively coupled to the streaming system. Users may specify events, data types, and/or time ranges for visualization, which the system may process by referencing the metadata file to locate the requested data in the primary data file. For example, a user analyzing vehicle performance during an event may request only radar detections and planned trajectories for a specific time range. The system may retrieve, based on indices in the metadata file, portions of these data types corresponding to specific byte ranges in the primary data file, minimizing unnecessary processing and data transmission.

Known techniques for visualizing log data may require users to manually interpret large log files or download excessive amounts of unrelated data. Methods according to known techniques may be particularly inefficient when dealing with cloud-based storage environments, where bandwidth constraints may limit performance. Disclosed methods and systems may address these inefficiencies by enabling selective streaming of only relevant data types and only relevant time ranges of those data types. For example, an exemplary system may retrieve optical sensor frames and detected object models for a specified event, while bypassing unrelated data such as braking system states or GPS signals. This targeted approach may reduce file transfer sizes and improve playback speeds.

With a resulting visualization, a user may explore different aspects of the specified event and correlate system states and message data with operational occurrences such as faults, anomalies, and/or performance deviations. For example, a user may analyze the response of the actuation system to a planned trajectory adjustment during an obstacle avoidance maneuver, correlating the timing and accuracy of the response to performance criteria. By enabling precise log data retrieval and reducing the size of data transmitted to a visualization platform, disclosed methods and systems enable more targeted user analyses and automated system analyses to be performed, reduce bandwidth usage and computational resource usage, and reduce the time associated with debugging, feature validation, and/or performance analysis tasks.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

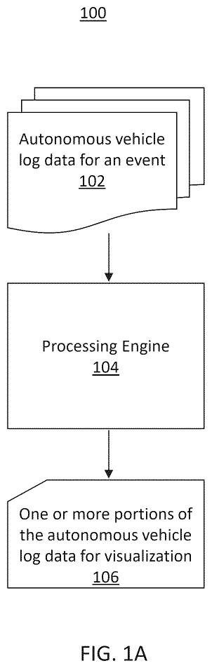

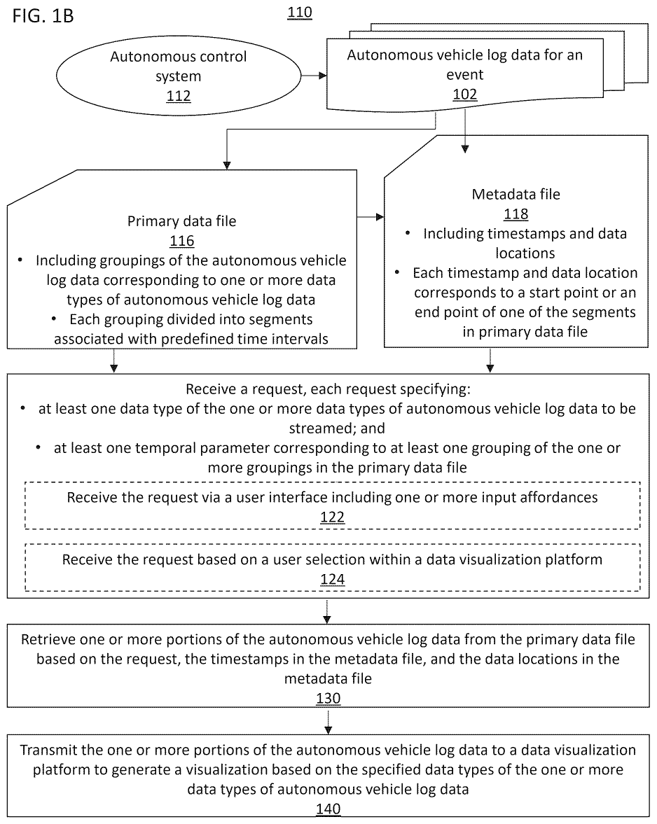

FIG. 1A depicts an exemplary system 100 for streaming autonomous vehicle log data to a visualization platform. Visualization of autonomous vehicle log data may enable analysis of vehicle performance, debugging of the autonomous control system, and/or validating of new features under various operational configurations. For example, autonomous control system developers or engineers may use visualizations to probe how the vehicle's sensors and/or systems responded during a particular event. For example, autonomous control system performance vis-à-vis, for example, obstacle detection and/or intersection navigation may be analyzed. Additionally or alternatively, developers and other users may use exemplary streaming system 100 along with visualization tools to conduct simulations testing new features, and/or evaluating system responses to edge cases and/or novel scenarios. Visualization platform interfaces may enable overlays of sensor data, such as LiDAR point clouds and/or optical sensor images, alongside annotations, planned vehicle trajectories, and/or system states, providing a comprehensive view of the vehicle's operation throughout the visualized sequence of vehicle operations.

System 100 may include a processing engine 104 that may retrieve one or more portions 106 of autonomous vehicle log data relevant to a visualization based on an input of autonomous vehicle log data 102 generated during a single event. Autonomous vehicle log data 102 may include information captured during operation, testing, and/or simulation of the autonomous vehicle, for example the autonomous control system of the vehicle. An event may represent a defined period of operation, testing, and/or simulation, for example an event may represent a particular activity or occurrence involving the autonomous vehicle. An event may correspond to a portion of a test drive or a data collection session, for example a test of the perception system of the autonomous vehicle during which the vehicle remains stationary. Data recording of an event may be triggered, for example, by a user interacting with the user interface of the autonomous vehicle, for example issuing a command to initiate data recording or logging. A command to initiate recording may be issued ahead of a planned test or operational sequence. Additionally or alternatively, a command to initiate recording may be issued in response to an unexpected occurrence or glitch in the operation, testing, and/or simulation of the autonomous vehicle, to allow the issue to be debugged once recording is complete. Such commands may include a specification of which message data types to record and/or a recording duration.

In some implementations, an event may correspond to a particular time period, such as a predetermined duration over which data is continuously recorded before a transition to a new log file is initiated. For example, an event may correspond to data recorded during a maximum recording interval, for example 35 seconds. By implementing a maximum recording interval, an autonomous control system may manage the size of log data files generated. For test drives or recording sessions lasting longer than the maximum recording interval, a series of log data files may be created. In this case, data recording for each subsequent log data file may begin immediately after data recording for the previous log data file is completed, ensuring the series of log data files may be generated that cover the duration of the test drive or autonomous vehicle operation session. Creation of such a series of log data files, in place of one large log data file may enable log data to be organized into manageable portions for subsequent processing.

Autonomous vehicle log data 102 may include message data corresponding to autonomy messages exchanged by constituent systems of the autonomous control system of the vehicle. This message data may represent signals, states, and/or commands corresponding to the inputs and/or outputs of these systems. This message data may correspond to multiple different data types including, for example, sensor data (e.g. data from LiDAR sensors, radar sensors, and/or optical sensors) and/or vehicle system data (e.g. braking status, steering commands, and/or autonomous control system status messages). Log data 102 may be organized based on time, with chunks containing multiple data types stored sequentially.

Processing engine 104 may include one or more physical computing components configured to process and/or retrieve log data for visualization. For example, processing engine 104 may be a server-based system operating in a cloud computing environment including distributed resources to manage large volumes of autonomous vehicle log data. Additionally or alternatively, processing engine 104 may be a standalone hardware device, such as an edge computing unit, located near the autonomous vehicle. In some implementations, processing engine 104 may include specialized hardware optimized for processing and/or indexing autonomous vehicle log data efficiently.

Processing engine 104 may be configured to interpret, stratify, and/or transform autonomous vehicle log data 102 for subsequent use in visualization. The processing engine may receive log data 102 from a storage system such as a cloud-based storage environment that may include autonomy message data arranged based on measurement time. Processing engine 104 may process log data 102 to instead arrange it by data type with data of a particular type organized by time as explained in further detail below. Processing engine 104 may further create metadata corresponding to the processed log data, including indices that may map message data type and measurement time to particular data location ranges within the processed log data, for example byte ranges. This stratification and indexing of data may enable system 100 to process and retrieve only the portions of the log data, such as one or more portions 106, that are relevant to a specific visualization request.

One or more portions 106 of the autonomous vehicle log data may represent a subset of the overall log data tailored to a particular visualization configuration. For example, when visualizing lane line projections in a data visualization platform, one or more portions 106 may include only message data corresponding to relevant data types, such as optical sensor frames and/or related perception system variables such as detected lane line type and/or position. Similarly, one or more portions 106 may correspond to a specified temporal interval, such as message data recorded during a particular test event or during a user-defined time range.

By processing and retrieving only a portion of log data, system 100 may reduce the amount of data transferred from a remote storage environment such as a cloud-based environment to a local environment on which a visualization platform is operating. This reduced data transfer size may in turn reduce time taken to transmit data to the visualization platform, enabling streaming of extended periods of autonomous vehicle log data without pausing to allow additional data to be transferred.

FIG. 1B depicts an exemplary process 110 for streaming log data of an autonomous vehicle to enable visualization of a portion of the log data. As mentioned above, autonomous vehicle log data 102 may be generated for a particular event, such as driving sessions, diagnostic tests, and/or simulated scenarios, and may be received from a control system 112 of an autonomous vehicle. Control system 112 may record autonomy message data exchanged and/or generated by its constituent systems during the particular event, forming the basis of autonomous vehicle log data 102. Autonomous control system 112 may include one or more systems to carry out autonomy functions, including, for example, a planning system, a perception system, an actuation system, and/or a localization system.

For example, the planning system may generate message log data reflecting operational decisions made to dictate the response of the autonomous vehicle. For example, log data generated by the planning system may reflect planned trajectories, maneuvers to avoid nearby roadway actors, and/or navigational adjustments, based on data inputs from, for example, the perception and/or localization systems. The perception system may process sensor data, such as LiDAR point cloud data, optical sensor images, and/or radar signals, to identify and classify objects, detect lane line geometry, and/or assess environmental conditions, logging messages corresponding to its inputs and/or outputs as part of the autonomous vehicle log data 102. The actuation system may execute commands generated by the planning system to control vehicle operations, including steering, braking, and/or acceleration, while recording in log data 102 actuation command and response messages from, for example, steering column and/or braking system actuators. The localization system may determine the vehicle's precise position and orientation, with log data reflecting inputs from GPS and/or IMU sensors as well as outputs reflecting the autonomous vehicle's computed position and orientation.

Log data 102 may include messages data representing signals, states, and/or commands corresponding to the inputs and/or outputs of the aforementioned systems making up the autonomous control system of the vehicle. For example, the planning system may generate data including “trajectory_coordinates,” defining a series of coordinates representing the intended path of the vehicle, and “maneuver_type,” that may indicate a specific maneuver type, such as a lane change or deceleration. Additional planning system data that may form part of log data 102 may include “command_speed,” specifying the desired velocity at a given time and/or “adjustment_basis,” which may describe reasons for navigational adjustments such as a detected road closure.

Log data 102 may further include messages generated by the perception system including, for example, “object_classification,” specifying a class of a detected object (e.g. vehicle, pedestrian, and/or cyclist), “lane_line_curvature,” storing a variable representing the curvature of detected lane boundaries, and/or “free_space_boundary,” identifying the navigable area proximate to the autonomous vehicle as a set of boundary points. Outputs from the actuation system may contribute further message data to log data 102, such as “steering_angle_command,” specifying a commanded steering angle and/or “braking_force,” specifying the commanded braking force. Localization system data, such as “current_pose,” may define the vehicle's position and orientation and be included in log data 102.

These message data values may be stored as binary data within the log files, with each signal encoded according to a predefined schema and/or represented as specific byte sequences. For example, “trajectory_coordinates” may be stored as a sequence of floating-point numbers, for example 32-bit floating-point numbers with each coordinate occupying 4 bytes. Further, “maneuver_type” and/or “object_classification” may be encoded in binary, for example as 4-byte integers representing a particular vehicle maneuver type and/or detected object classification type, respectively. The use of a binary format may enable efficient storage, with each signal occupying a precise range of bytes within a log file, allowing for compact data representation and a reduction in overall file size relative to text-based formats.

As mentioned above, the binary data forming autonomous vehicle log data 102 may be organized in a temporally sequential manner with chunks of data containing multiple different message types. Such a file format may introduce inefficiencies during log data retrieval and/or streaming. For example, when a visualization involves only specific message data types, such as object classification and/or planned trajectory data, data retrieval according to known techniques may involve retrieving entire chunks containing unrelated data types, such as LiDAR point clouds and/or steering actuation commands. This over-fetching of data may increase bandwidth usage and/or slow down retrieval of a temporal sequence of log data to support a replay associated with the visualization. Additionally, mixed-type chunks may complicate techniques used to selectively access portions of the chunks, for example based on a requested data type and/or temporal range.

System 100 may process autonomous vehicle log data 102 to generate a primary data file 116 for a particular event. To generate primary data file 116, system 100 may form groupings of log data 102, with each grouping corresponding a single type of message data of autonomous vehicle log data, for example individual records and/or binary data corresponding to sensor outputs, control signals, and/or system states. In the above examples, one grouping within primary data file 116 may correspond to each of “object_classification,” “lane_line_curvature,” and/or “free_space_boundary” message data. System 100 may further stratify each grouping based on the time at which message data was generated by autonomous control system 112. For example, each grouping may be arranged in chronological order. A first portion of message data with earlier timestamps may be placed at an earlier location in primary data file 116 relative to a second portion of message data with later timestamps.

Groupings of each message data type may be further divided into segments associated with time intervals, for example predefined and/or user-specified time intervals. For example, message data within a particular grouping may stratified by generation time and may be further divided into segments, wherein each segment corresponds to data generated within a predefined time segment, for example a two-second long segment.

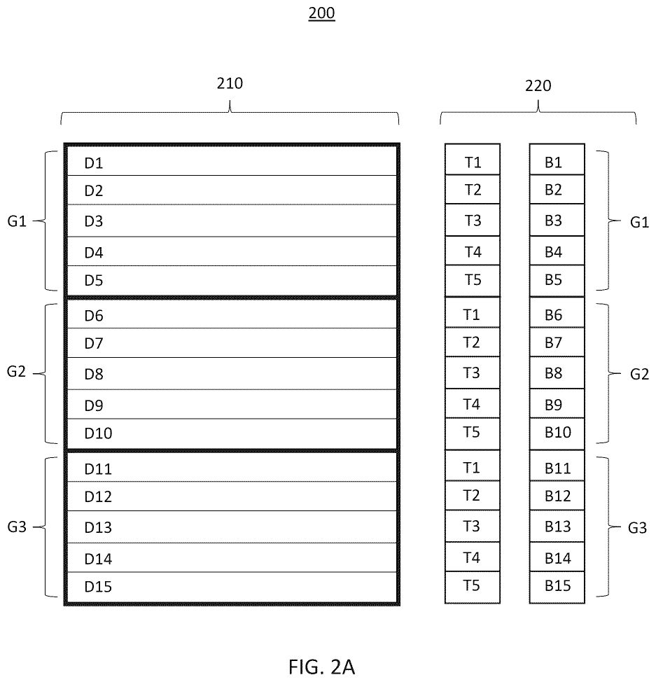

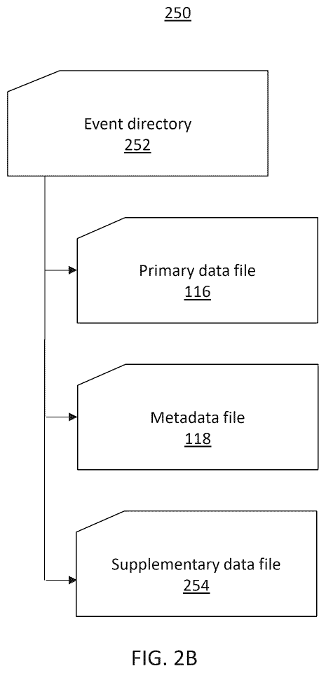

System 100, in generating primary data file 116, may thus stratify autonomous vehicle log data 102, recorded for a particular event, into groupings based on message data type. System 100 may divide each grouping into temporal segments corresponding to a predefined time period. As shown in view 200 of FIG. 2A, an exemplary primary data file 210 may thus be composed of a sequence of groupings, for example groupings G1, G2, and G3, each corresponding to a particular message data type and arranged sequentially in exemplary primary data file 210. Each grouping may be divided into one or more data segments, for example five data segments for each grouping: data segments D1, D2, D3, D4, D5 for grouping G1; data segments D6, D7, D8, D9, D10 for grouping G2; and data segments D11, D12, D13, D14, D15 for grouping G3.

Each data segment may correspond to data recorded for a predefined time interval, for example two seconds. Thus, each of the aforementioned data segments may correspond to a two-second time range, for example time ranges T1, T2, T3, T4, and T5. Because each of groupings G1, G2, and G3 may have been recorded simultaneously during the event represented by exemplary primary data file 210, each of time ranges T1, T2, T3, T4, and T5 of each grouping may overlap with one another. For example, the starting and ending timestamps of time range T1 of grouping G1 may match the starting and ending timestamps of time range T1 of groupings G2 and G3. Further, because data segments D1-D15 may be listed sequentially in exemplary primary data file 210, each data segment may correspond to a particular data location range or byte range. That is data segments D1, D2, D3, D4, D5, D6, D7, D8, D9, D10, D11, D12, D13, D14, and D15 may correspond to byte ranges B1, B2, B3, B4, B5, B6, B7, B8, B9, B10, B11, B12, B13, B14, and B15, respectively.

Indices may map, for each data type corresponding to each grouping, time ranges to byte ranges, allowing a user to specify one or more data types and one or more time ranges for data retrieval. These indices may be included in a metadata file for the particular event, e.g. a metadata file corresponding to the primary data file as described further below. In FIG. 2A, for example, exemplary metadata file 220 may include indices mapping timestamps T1-5 of groupings G1-3 to byte ranges B1-15 corresponding to data segments D1-15 of exemplary primary data file 210. These metadata file indices may enable system 100 to map message data type and/or temporal range to particular data locations or byte ranges within primary data file 116. This mapping in turn may enable system 100 to retrieve portions of data relevant to a visualization request from primary data file 116 in a targeted manner, minimizing the over-fetching of data.

As discussed above, system 100 may generate a metadata file 118 corresponding to the same event as primary data file 116 and serving to provide an index for primary data file 116. As shown in FIG. 2A, metadata file 118 may map, for each grouping of groupings G1-G3, a time range of time ranges T1-5 to a byte range of byte ranges B1-B15 corresponding to data segments D1-15 exemplary primary data file 210. Metadata file 118 may thus take the form of a listing of information for individual data segments of primary data file 116. For example, metadata file 118 may include for each data segment a starting and ending timestamp and a starting and ending byte or data location. In this way, each timestamp and data location may correspond to a start point or an end point of one of one or more segments in the primary data file. Each starting and ending timestamp may correspond to the times the recording of a particular data segment began and ended, each optionally separated by a predefined and/or user-specified time interval, for example two seconds. Each starting and ending byte may correspond to those starting and ending timestamps for a particular message data type, for example “object_classification” and may correspond to particular locations within primary data file 116, for example byte numbers 852 and 1456.

Metadata file 118 may include additional contextual information such as schema information defining the structure and/or format of each data type, ensuring compatibility and interpretability during retrieval and visualization. For example, schema information may describe the data type (e.g. integer or floating-point), the encoding format (e.g. IEEE 754 for floating-point), and/or the expected field structure (e.g. arrays of coordinates for “trajectory_coordinates”). Metadata file 118 may further include information on compression methods used for primary data file 116, such as gzip or zstd, to facilitate decompression during retrieval. Metadata file 118 may include an indication or a list of the one or more data types of autonomous vehicle log data in the primary data file.

Once generated, system 100 may place primary data file 116 and metadata file 118 into a file structure denoting the particular event that each file corresponds to. For example, as shown in FIG. 2B, primary data file 116 and metadata file 118 may be organized into a hierarchical file structure 250 that may include an event directory 252 labeled based on a unique event identifier, such as a 36-character alphanumeric string or Universally Unique Identifier. Within event directory 252, primary data file 116 and metadata file 118 may be stored in subdirectories and labeled based on their roles. For example, primary data file 116 may be labeled “primary_data.bin” indicating the file is a binary data file. Metadata file 118 may be labeled, for example, “metadata.json” indicating it is a JSON file containing human-readable metadata. Event directory 252 may additionally include a supplementary data file 254 that may store contextual information associated with the event. For example, supplementary data file 254 may include a starting time of the event and/or notes indicating the content of the event, for example a testing, operational, and/or simulation occurrence that triggered the event recording session. Use of file structure 250 may ensure data associated with many events, for example those corresponding to an extended data logging session, may be stored in an indexed manner. Use of file structure 250 may also simplify retrieval of primary data file 116 and metadata file 118 following receipt by system 100 of a request specifying the particular event the two files are associated with, for example a request specifying the unique event identifier of the particular event.

Primary data file 116 and metadata file 118 may be generated following generation of autonomous vehicle log data 102 for an event. For example, a log data 102 may be uploaded to a storage environment, for example a cloud-based storage environment, from an autonomous vehicle. Once available within the storage environment, system 100, which may be operating within the storage environment, may preprocess log data 102 of the event. Additionally or alternatively, system 100 may generate primary data file 116 and metadata file 118 for an event upon receipt of a request for data associated with the event from a user as discussed below.

Following formation of primary data file 116 and metadata file 118, at step 120 of process 110, both primary data file 116 and metadata file 118 may be used to process a requests for data, for example to form a visualization based on the data. Requests for data may be received, at step 122, based on selections by a user of one or more input affordances of a user interface of system 100 communicatively coupled to a robotics or autonomous vehicle data visualization platform including, for example, Foxglove, RViz, and/or Webviz. User interface 300 may include a standalone application, for example a desktop application or web application, that is communicatively coupled to the data visualization platform. Additionally or alternatively, user interface 300 may be a plugin application within the data visualization platform, for example, a module or extension integrated into the platform's existing interface. Additionally or alternatively, requests for data may be received, at step 124, based on selections by a user within the data visualization platform communicatively coupled to system 100.

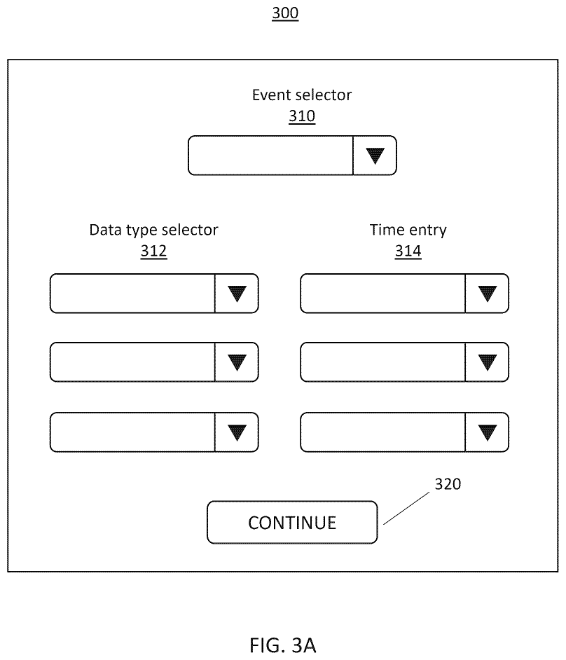

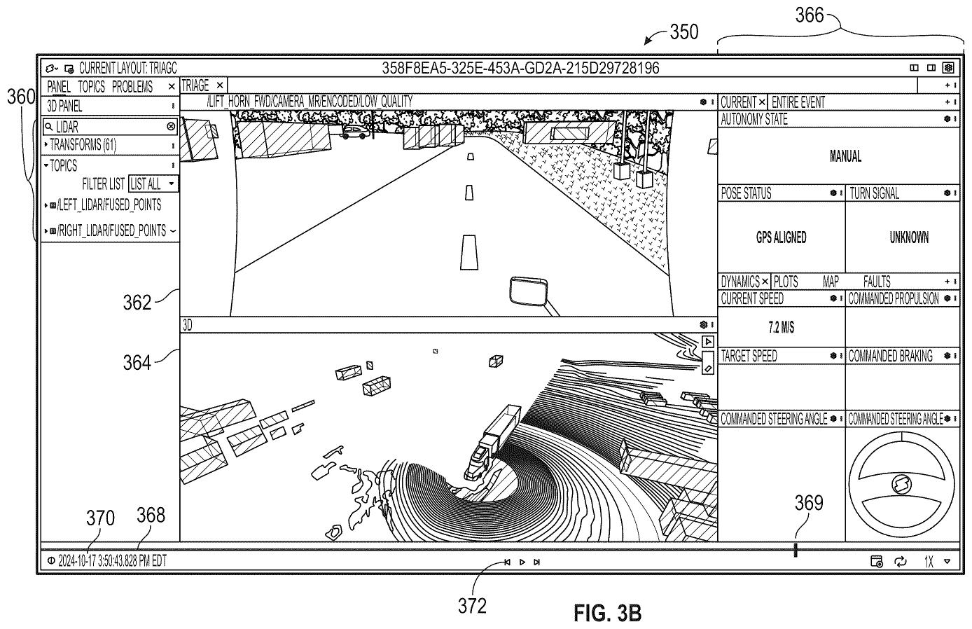

For example, as depicted in FIG. 3A, an exemplary user interface 300 of system 100 may include one or more input and/or control affordances. For example, user interface 300 may include an event selector affordance 310, one or more data type selector affordances 312, one or more time entry affordances 314, and/or a control affordance 320. System 100 may display on user interface 300, via event selector affordance 310, initialization metadata, for example a listing of one or more events available for selection. Event selector affordance 310 may take the form of a dropdown menu with initialization metadata associated with the one or more events available for selection displayed within a list in the dropdown menu. A user may select one or more of the events available for example by checking a checkbox corresponding to the one or more events.

Exemplary initialization metadata may include, for example, information within a file structure, such as file structure 250, corresponding to the event. For example, system 100 may display on user interface 300, via event selector affordance 310, unique event identifiers associated with the one or more events available for selection and/or contextual data such as that contained in supplementary data files such as supplementary data file 254. Exemplary contextual data displayed may include a starting time of the event and/or operator notes on the content of the event including, for example, a testing, operational, and/or simulation occurrence that triggered the event recording session.

Once a user has selected an event of interest, system 100 may use metadata file 118 associated with the event to display on the user interface information corresponding to the message data types and/or time ranges included within primary data file 116, for example using one or more data type selector affordances 312 and/or one or more time entry affordances 314. One or more data type selector affordances 312 may allow a user to choose specific message data types for visualization, such as LiDAR point clouds, radar detections, and/or lane projections. To simplify batch entry, one or more data type selector affordances 312 may support hierarchical groupings of data types by autonomous control subsystem (e.g. perception, planning, and/or localization) and/or analysis type, enabling a user to select, with a single action, all data types corresponding to a specific autonomous control subsystem and/or to a particular type of analysis or visualization. For example, these batch selection options may allow a user to select all message data associated with the autonomous vehicle's perception system, and/or all message data required to visualize detected objects, such as object classifications, bounding boxes, and/or confidence scores. One or more time entry affordances 314 may enable a user to specify temporal parameters, such as a single timestamp, a start and end time for a desired range, and/or a custom time intervals such as “final 10 seconds.”

To enable specification of requested data types and/or temporal parameters, one or more data type selector affordances 312 and/or one or more time entry affordances 314 may include a list in the form of a dropdown menu, a text entry field, and/or a combination of the two. A combination of the two input affordance types may enable a user to use the dropdown menu to browse available message data types and/or available time ranges, and/or to type text into the text entry field to search for a particular message data type and/or a particular time range. A user may select one or more of the data types and/or time ranges available for example by checking a checkbox corresponding to the data type and/or time range. Additionally or alternatively, with respect to one or more time entry affordances 314, a user may enter custom time information, for example “final 10 seconds,” that system 100 may use to associate with and select one or more time ranges within primary data file 116 using metadata file 118.

In some implementations, in addition or as an alternative to a dropdown menu or text entry field, one or more time entry affordances 314 may include one or more slider affordances. Slider affordances may allow a user to adjust a start handle and/or an end handle along a timeline bar to specify a desired time range associated with a selected data type. In some implementations, system 100 may interpret selection by a user of only one or more data types via one or more data type selector affordances 312 as indicating that the user is requesting all available time ranges corresponding to the selected event. In some implementations, system 100 may interpret selection by a user of only a time range via one or more time entry affordances 314 as indicating that the user is requesting all available data types.

In this way, using each row of one or more data type selector affordances 312 and/or one or more time entry affordances 314, a user may specify requests for pairings of message data types and time ranges associated with a selected event for inclusion in a visualization. For example, a user may request LiDAR message data for a specified 10-second time interval. The user may then finalize their request by selecting, for example, control affordance 320. This may signal to system 100 that the user's request is complete, allowing system 100 to use the indices present in metadata file 318 to map, for the selected event, the input message data types and time ranges to particular groupings within primary data file 116 corresponding to the input message data types and specific data locations or byte ranges within those particular groupings.

To request data from multiple events, for example a series of events corresponding to a data recording session extending beyond the maximum recording interval of individual events, a user may repeat the above-described process for each event in series, for example selecting control affordance 320 after each entry corresponding to each event. Alternatively or additionally, user interface 300 may include multiple event selector affordances 310 each corresponding to a set of one or more data type selector affordances 312 and/or one or more time entry affordances 314, thereby enabling a user to enter data requests associated with multiple events in parallel. In some implementations with a user interface 300 with multiple event selectors 310, system 100 may prevent the selection of the same event or unique event identifier within multiple event selectors 310 to prevent a user from accidentally requesting data from the same event twice.

As described above, requests for data may be additionally or alternatively received, at step 124 of process 110, based on selections by a user within the data visualization platform communicatively coupled to system 100. For example, a plugin may be installed such that user selections made within the data visualization platform may be transmitted to system 100. This plugin may act as an intermediary interface, integrating with the visualization platform's native functionality to capture user inputs, such as selected data types, temporal ranges, and/or event identifiers. The plugin may then format these inputs into structured requests compatible with the data retrieval processes of system 100.

Additionally or alternatively, when a user initiates playback within the visualization platform, the plugin may generate and transmit event-driven metadata updates to system 100. For example, when a user presses play, the plugin may generate a playback event message indicating the playback start time and transmit this information to system 100. System 100 may then interpret the received playback event message and generate a corresponding remote procedure call to the storage environment that specifies the appropriate time range for retrieval, for example the three seconds that follow the playback start time. Such a configuration may allow a user to interact directly with the visualization platform's interface while leveraging the backend capabilities of system 100 for precise and efficient data retrieval.

An exemplary data visualization platform may provide an interactive interface allowing a user to configure panels or views for specific data types. For example, as depicted in FIG. 3B, an interface of a data visualization platform 350 may include one or more data entry affordances 360, visualization panels 362 and/or 364, one or more data indication affordances 366, a playback bar 368, and/or an indication of the measurement or data recording time 370 currently being visualized. As shown in FIG. 3B, visualization panel 362 of interface 350 may include an overlay of detected object models onto optical sensor frames. Visualization panel 364 may include an overlay of detected object models onto LiDAR point cloud data, along with a visual representation of the autonomous vehicle, in this case a tractor trailer. One or more data indication affordances 366 may include indications of message data types corresponding to the state of autonomy control, a GPS status, a turn signal status, a measured velocity, a commanded velocity, an actuation system state such as a state of the propulsion or braking system, a measured steering wheel angle, and/or a commanded steering wheel angle. Generation of the one or more data type selector affordances 312 and/or the one or more data indication affordances 366 may be based on information contained within metadata file 118, for example an indication or list of the one or more data types in the primary data file.

One or more data entry affordances 360 may include some or all of the functionality included within user interface 300 described in the context of FIG. 3A. For example, one or more data entry affordances 360 may include one or more event selector affordances to select one or more events from a listing of events available for selection based on initialization metadata provided by system 100, for example by checking a checkbox corresponding to the one or more events. Once one or more events have been selected, similar to user interface 300, a user may make a request for one or more message data types and/or one or more time ranges based on metadata 118 provided by system 100.

A user may make these requests using one or more data entry affordances 360 of interface 350 which, similar to user interface 300, may include, for example, one or more text entry fields, one or more dropdown menus, and/or one or more slider bars. To select one or more data types a user may, for example, search for a particular data type by typing the data type name within a text entry field, and/or may browse for a particular data type within a list of a dropdown menu, selecting a data type using a corresponding checkbox. To select one or more time ranges, in addition or as an alternative to using a dropdown menu and/or text entry field as described above, a user may use one or more slider affordances. Slider affordances may allow a user to adjust a start handle and/or an end handle along a timeline bar to specify a desired time range associated with a selected data type.

Additionally or alternatively, by opening a visualization panel or visualization display type such as visualization panel 360 and/or 362, corresponding to one or more data types such as optical sensor frames, detected object models, and/or LiDAR point cloud data, a user may initiate a request for system 100 to retrieve the data types necessary to enable the visualization. To specify one or more time ranges associated with the visualization panel, the user may drag a slider handle along playback bar 368, and/or may specify a particular time range by adjusting a start handle and/or an end handle along playback bar 368, confirming the start and end times specified using indication of the measurement or data recording time 370. Similarly, a user may open one or more data indication affordances, such as data indication affordances 366, corresponding to one or more data types such as autonomy control state, GPS state, turn signal state, measured velocity, commanded velocity, actuation system state, measured steering wheel angle, and/or commanded steering wheel angle. Opening of such data indication affordances may serve to initiate a request for system 100 to retrieve the data types necessary to enable the display of the relevant data types on the affordances. As described above, a user may use playback bar 368 and/or indication of the measurement or data recording time 370 to specify one or more time ranges associated with the data indication affordances.

Additionally or alternatively, a user may specify one or more time ranges by selecting at least one playback position. For example, a user may place playhead affordance 369 at one or more positions along playback bar 368, for example to view the portion of the visualization corresponding to said one or more positions. System 100 may generate a request for one or more time ranges based on the position of playhead affordance 369, for example requesting a time range starting at the position of playhead affordance 369 and ending at a point in time in the future, for example three seconds in the future. In some implementations, system 100 may dynamically adjust the retrieval process based on user interactions with the playback bar. For example, if a user scrubs back and forth along playback bar 368, system 100 may prioritize retrieval of autonomous vehicle log data for frequently accessed time ranges to improve responsiveness.

In some implementations, system 100 may retrieve backfill data before playback begins, ensuring that the data visualization platform has access to relevant message data for the selected topics at the initial time frame displayed. For example, before a user starts playing a visualization, system 100 may issue a request in the form of a remote procedure call to retrieve from the primary data file the messages closest to the current playback position. This may include retrieving the message for each selected data type that has a timestamp closest to the specified playback position, whether slightly before or slightly after the exact time of the position, based on available log data. If multiple messages exist within a small time window around the specified position, system 100 may select the message with the nearest timestamp and/or interpolate between messages. For example, when a user scrubs to a new position along playback bar 368 before initiating playback, system 100 may request backfill data at the newly selected time position to ensure that the visualization platform has the latest message data closest to the new playback position.

In some implementations, system 100 may support data preloading in which, for particular one or more data type groupings, system 100 may retrieve all segments within a temporal range extending from a start point of the event to an end point of the event from the primary data file. This may be particularly useful for visualizing continuous data such as plots, where the full historical context of a signal may be beneficial for analysis, instead of discrete time segments of the signal.

In some implementations, when a user starts playback within the data visualization platform, for example by selecting a play button, the platform and/or a plugin installed within the platform may transmit a message to system 100 indicating the start time of the playback. In response, system 100 may divide the remaining autonomous vehicle log data, corresponding to a period of time from the start point to the end point of the event, into sequential temporal ranges of a predefined length, for example into three-second intervals. For example, if the user starts playback at 10 seconds into an event that is 30 seconds long, system 100 may generate retrieval requests for the following temporal ranges: 10 seconds to 13 seconds, 13 seconds to 16 seconds, 16 seconds to 19 seconds, 19 seconds to 22 seconds, 22 seconds to 25 seconds, 25 seconds to 28 seconds, and 28 seconds to 30 seconds.

Once system 100 has divided log data into temporal ranges, system 100 may retrieve log data portions corresponding to one or more of the temporal ranges. Once portions corresponding to one or more of the temporal ranges have been retrieved, each portion may be sequentially transmitted to the data visualization platform, optionally in the form of a byte stream. In the above example, if a user begins playback at 10 seconds, system 100 may first transmit a portion of log data corresponding to the 10 seconds to 13 seconds temporal range for one or more specified data types. System 100 may subsequently transmit a portion of log data corresponding to a temporal range immediately adjacent to the 10 seconds to 13 seconds temporal range, for example the 13 seconds to 16 seconds temporal range. System 100 may subsequently transmit the 16 seconds to 19 seconds temporal range, the 19 seconds to 22 seconds temporal range, and so on, for the one or more specified data types. Additionally or alternatively, system 100 may transmit two temporal ranges separated from one another by one or more other temporal ranges, for example to enable visualization of two phenomena of the event taking place at discrete times.

The visualization platform may begin processing this byte stream as soon as the first portion of log data is received, allowing real-time rendering of visualization elements without waiting for retrieval of subsequent portions. That is, the visualization may be updated as additional portions of the autonomous vehicle log data are transmitted to the data visualization platform. This progressive loading mechanism may reduce latency, as the visualization can begin with minimal buffering. System 100 may continue requesting and streaming subsequent portions of log data in sequence, ensuring that only the log data relevant to the user's visualization is transmitted.

If the specified time range for an autonomous vehicle log data replay corresponds to a significant duration, retrieval by system 100 may be initiated for a portion of data from primary data file 116 corresponding to initial time ranges of the time ranges requested, allowing the visualization to commence with minimal delay. Once the visualization has begun playing, system 100 may retrieve one or more portions of data corresponding to subsequent time ranges, enabling data to be streamed to the visualization platform from the data storage location while minimizing loading or buffering time. By retrieving only data relevant to the immediate visualization, the time to begin playing a visualization, and any delays resulting from buffering or retrieving data, may be further reduced relative to known data log streaming techniques.

Providing a request for one or more data types and/or one or more temporal parameters by opening a visualization panel and/or a data indication affordance may enable a user to additionally specify one or more events that include the requested one or more data types and/or one or more temporal parameters. For example, if an extended recording session covers multiple events, a user may specify a period of the session covering the multiple events, for example by adjusting a start handle and/or an end handle along playback bar 368. This may serve as the basis for a request to system 100 including each of the events in the specified period. For example, metadata file 118 may include identifiers linking multiple sequential events generated during the same recording session, enabling system 100 to stream them more readily. By linking related events, system 100 may ensure continuity in data retrieval and visualization across event boundaries.

At step 130 of process 110, system 100 may retrieve one or more portions of autonomous vehicle log data from primary data file 116 based on the one or more requested data types and the one or more requested time ranges. System 100 may make this retrieval based on the indices in metadata 118 that may map specified time ranges to specific byte ranges within groupings in primary data file 116 corresponding to the specified data types. For example, metadata file 118 may include mappings for optical sensor frame data segments recorded during specific time intervals, allowing system 100 to locate byte ranges of those data segments within the grouping corresponding to the optical sensor frame data type in primary data file 116. If a user request specifies optical sensor frame data type for a given time range, system 100 may reference metadata file 118 to identify the corresponding byte ranges in primary data file 116 and retrieve a data portion including only the relevant data segments.

At step 140, system 100 may transmit the retrieved portion of autonomous vehicle log data from primary data file 116 to the data visualization platform via a network communication interface. The visualization platform may use the transmitted data to generate a visualization based on the one or more specified data types and corresponding time ranges. For example, as shown in FIG. 3B, the platform may generate the visualization of panel 362 of interface 350 that may include an overlay of detected object models onto optical sensor frames, or the visualization of panel 364 that may include an overlay of detected object models onto LiDAR point cloud data, along with a visual representation of the autonomous vehicle. Additionally or alternatively, the platform may display transmitted data in one or more data indication affordances 366 that may correspond to the state of autonomy control, a GPS status, a turn signal status, a measured velocity, a commanded velocity, an actuation system state such as a state of the propulsion or braking system, a measured steering wheel angle, and/or a commanded steering wheel angle.

The visualization panels and/or data indication affordances of the data visualization platform may be dynamically updated to play back the autonomous vehicle log data corresponding to one or more events in a temporally sequential manner. For example, playback bar 368, indication of the measurement or data recording time 370, and/or playback control affordances 372 may enable a user to navigate through a simulation playback, adjusting the timeline to focus on specific moments or intervals of interest. Playback control affordances may include features such as play, pause, fast-forward, rewind, and/or skip, allowing a user to review autonomous vehicle log data at varying speeds and/or to jump directly to key occurrences. A user may specify the temporal point within the event to be visualized by dragging the slider handle along playback bar 368, confirming the current position on the timeline using indication of the measurement or data recording time 370.

As mentioned above, for log data replays involving large datasets or extended periods, system 100 may retrieve data portions that match the portion of the log data corresponding to the initial or current portion of the visualization before retrieving log data portions corresponding to subsequent portions. This staggered retrieval may enable a log replay to begin, and continue, without significant loading or buffering delay. By retrieving only data relevant to a particular visualization, instead of retrieving data types not included in a visualization, system 100 further improves upon the data retrieval and visualization benefits derived from such staggered approaches. This further benefit may be derived from the reduction in transmitted data size, which may have significant load-time benefits in bandwidth-limited situations, for example when retrieving log data from a cloud-computing storage environment.

System 100 may continue to receive new requests, and transmit new autonomous vehicle log data, from one or both of user interface 300 or interface 350 of the visualization platform during the visualization phase. For example, a user may modify their selections of one or more data types and/or one or more time ranges, or make new selections, while a visualization corresponding to existing selections is playing back. In such a case, system 100 may process these updated requests, retrieving only the newly specified data to allow the visualization platform to integrate this new data into a new or existing visualization. Such dynamic request handling may ensure that users can explore and analyze log data without needing to restart the visualization process.

In this way system 100, by streaming log data to the data visualization platform, may facilitate detailed analysis of recorded events, enabling a user to correlate system states and message data with operational occurrences such as faults or errors. The ability to visualize specific data types, such as sensor outputs or actuation commands, in combination with corresponding timestamps and operational states, may allow a user to reconstruct the sequence of events leading to a fault or error. For example, a user may analyze the response of the autonomous control system of the vehicle during a specific event to identify patterns, anomalies, and/or to make comparisons to one or more performance criteria. Such analysis may include evaluating whether actuation commands, such as those affecting the braking or steering systems, were executed as intended or whether perception data, such as detected object classifications, were made in an accurate and timely manner.

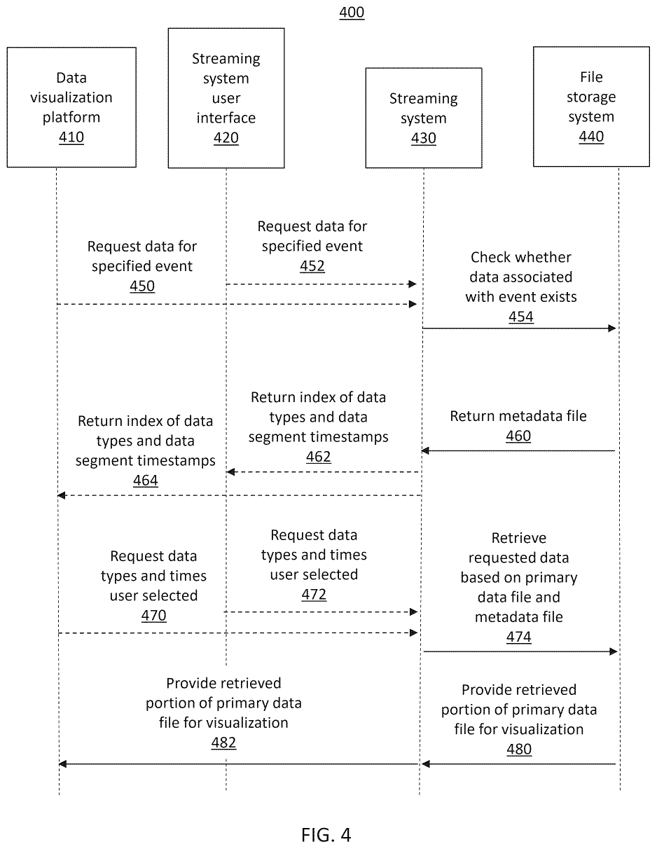

FIG. 4 depicts a swimlane diagram illustrating an exemplary workflow 400 for streaming log data of an autonomous vehicle for visualization. Workflow 400 may involve multiple systems or interfaces: a data visualization platform 410 (e.g. the user interface of which is depicted in FIG. 3B), a streaming system user interface 420 (e.g. user interface 300 of FIG. 3A), a streaming system 430 (e.g. system 100), and/or a file storage system 440 (e.g. a cloud-based storage environment). As discussed above, data visualization platform 410 may include a tool such as a desktop application or web application capable of displaying visualizations of autonomous vehicle log data, such as detected objects and/or vehicle trajectories. User selections in data visualization platform 410 may form the basis for requests for vehicle log data, similar to the function of stream system user interface 420. Streaming system user interface 420 may serve as an intermediary, allowing a user to specify parameters such as event, data types, and/or time ranges for visualization via one or more input affordances.

Streaming system 430 may act as the core processing engine, preprocessing autonomous vehicle log data to generate primary data files such as primary data file 116 and metadata files, such as metadata file 118, indexing corresponding primary data files. Streaming system 430 may additionally handle data retrieval requests, interpreting metadata and streaming relevant portions of log data to the data visualization platform. File storage system 440 may serve as a repository for raw autonomous vehicle log data files and processed primary data files and metadata files, organized by event for efficient access. File storage system 440 may reside in a cloud-based storage or local server environment.

As mentioned above, the preprocessing of autonomous vehicle log data and/or the extraction of relevant portions of log data based on a streaming request by referencing an index within a metadata file may be performed on the file storage backend, where bandwidth constraints may be minimal or non-existent. Thus, such data processing and extraction steps may be computationally intensive but not restricted by network transmission speeds, allowing large volumes of data to be processed efficiently. In contrast, transmitting or streaming those relevant portions to a visualization platform may be subject to bandwidth limitations, particularly if the visualization platform is running on a separate local computing environment.

For example, when log data is stored in a cloud-based environment, extracted data may be transmitted over a network communication interface to a local system where the visualization platform may be operating, with the transfer rate constrained by network bandwidth. This distinction between a bandwidth-unlimited file storage and/or data processing backend and a bandwidth-limited client environment highlights the advantage of performing data extraction before transmission, ensuring that only relevant portions of log data may be transmitted, thereby reducing analysis time.

At step 450, user selections within data visualization platform 410 may form a request transmitted to system 430 to retrieve data for a specified event. Alternatively or additionally, a user may use user interface 420 to specify an event, a request that may be directly transmitted to system 430 at step 452. These requests may include a unique event identifier associated with the event to be visualized. For instance, a user analyzing vehicle behavior during a test drive may select a timestamp or a unique event identifier associated with an event occurring during the test drive, prompting the request for relevant log data.

At step 454, system 430 may communicate with file storage system 440 to verify that data associated with the specified event exists. This check may include confirming the presence of both the primary data file and metadata file associated with the specified event. For example, if the event corresponds to a 20-second interaction at an intersection, system 430 may check whether data segments for that period have been recorded and stored in a primary data file.

Once the specified event's existence is confirmed, at step 460, system 430 may receive from file storage system 440 the metadata file associated with the specified event. This metadata file may contain indices mapping temporal parameters to byte ranges corresponding to portions of data type groupings within the primary data file associated with the metadata file. These indices may enable system 430 to efficiently retrieve the requested data from the primary data file associated with the metadata file.

At step 462, system 430 may transmit information from the returned metadata file, including an index of available data types and corresponding timestamps, to user interface 420. For example, the index may indicate that the event contains data types including LiDAR point clouds, radar detections, and/or optical image sensor frames, along with time ranges for each data type. Alternatively or additionally, at step 464, system 430 may directly send this index and timestamp data to data visualization platform 410. To which of user interface 420 or data visualization platform 410 the data is sent may depend on the origin of the data request for the specified event. For example, a request made from user interface 420 via step 452 may result in a return of index and timestamp data to user interface 420 via step 462. Likewise, a request made from visualization platform 410 via step 450 may result in a return of index and timestamp data to visualization platform 410 via step 464.

Next, at step 470, system 430 may receive a request originating from data visualization platform 410 specifying data types and time ranges selected by the user. Alternatively or additionally, at step 472, system 430 may receive the user's selection from the system's user interface 420. For example, the user may select the “object classifications” data type for the time range between 10 and 20 seconds into the event.

At step 474, system 430 may retrieve the requested data from file storage system 440 by referencing both the primary data file and the metadata file. The metadata file allows system 430 to identify the precise byte ranges associated with the requested portion or time intervals of the specified data types, ensuring efficient data retrieval without over-fetching unrelated data.

At step 480, system 430 may receive from file storage system 440 the retrieved portions of the primary data file. Finally, at step 482, system 430 may stream the retrieved data portions to data visualization platform 410, enabling the user to view and analyze in a visual format the selected data such as LiDAR point clouds, vehicle trajectories, and/or detected object models.

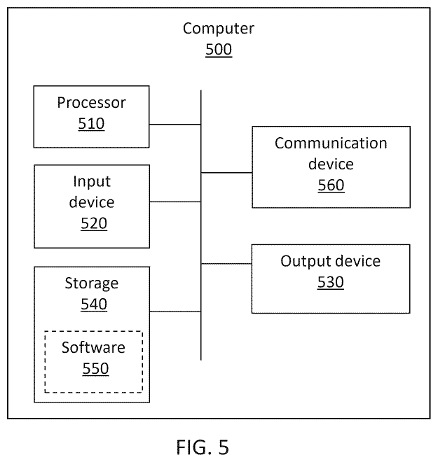

In one or more examples, the disclosed systems and methods utilize or may include a computer system. FIG. 5 depicts an exemplary computing system according to one or more examples of the disclosure. Computer 500 can be a host computer connected to a network. Computer 500 can be a client computer or a server. As shown in FIG. 5, computer 500 can be any suitable type of microprocessor-based device, such as a personal computer, workstation, server, or handheld computing device, such as a phone or tablet. The computer can include, for example, one or more of processor 510, input device 520, output device 530, storage 540, and communication device 560. Input device 520 and output device 530 can correspond to those described above and can either be connectable or integrated with the computer.

Input device 520 can be any suitable device that provides input, such as a touch screen or monitor, keyboard, mouse, or voice-recognition device. Output device 530 can be any suitable device that provides an output, such as a touch screen, monitor, printer, disk drive, or speaker.

Storage 540 can be any suitable device that provides storage, such as an electrical, magnetic, or optical memory, including a random-access memory (RAM), cache, hard drive, CD-ROM drive, tape drive, or removable storage disk. Communication device 560 can include any suitable device capable of transmitting and receiving signals over a network, such as a network interface chip or card. The components of the computer can be connected in any suitable manner, such as via a physical bus or wirelessly. Storage 540 can be a non-transitory computer-readable storage medium comprising one or more programs, which, when executed by one or more processors, such as processor 510, cause the one or more processors to execute methods described herein.

Software 550, which can be stored in storage 540 and executed by processor 510, can include, for example, the programming that embodies the functionality of the present disclosure (e.g., as embodied in the systems, computers, servers, and/or devices as described above). In one or more examples, software 550 can include a combination of servers such as application servers and database servers.

Software 550 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A method for streaming log data of an autonomous vehicle for visualization, the method comprising:
receiving autonomous vehicle log data for an event associated with operation of the autonomous vehicle;
generating a primary data file for the event comprising one or more groupings of the autonomous vehicle log data, wherein each grouping of the one or more groupings corresponds to a particular data type of one or more data types of autonomous vehicle log data and each grouping of the one or more groupings is divided into one or more segments associated with one or more predefined time intervals;
generating a metadata file for the event comprising one or more timestamps and one or more data locations, wherein each timestamp and data location corresponds to a start point or an end point of one of the one or more segments in the primary data file;
receiving a request specifying:
at least one data type of the one or more data types of autonomous vehicle log data to be streamed; and
at least one temporal parameter, wherein the at least one temporal parameter corresponds to at least one grouping of the one or more groupings in the primary data file; and
retrieving one or more portions of the autonomous vehicle log data from the primary data file based on the request, the one or more timestamps in the metadata file, and the one or more data locations in the metadata file; and
transmitting via a network communication interface the one or more portions of the autonomous vehicle log data to a data visualization platform to generate a visualization based on the specified data types of the one or more data types of autonomous vehicle log data.

2. The method of claim 1, wherein the event corresponds to an activity and a time period associated with operation of the autonomous vehicle.

3. The method of claim 1, wherein the method further comprises storing the primary data file and metadata file in a hierarchical data structure, the hierarchical data structure corresponding to a unique identifier for the event.

4. The method of claim 1, wherein the metadata file further comprises one or more schema definitions indicating a data format of the one or more data types of autonomous vehicle log data in the primary data file.

5. The method of claim 1, wherein the one or more data locations specify the byte location corresponding to a start point or an end point of one of the one or more segments in the primary data file.

6. The method of claim 1, wherein the method further comprises providing a user interface comprising one or more input affordances for selecting the event from a list comprising one or more events.

7. The method of claim 6, wherein the method further comprises providing a user interface comprising one or more input affordances for selecting, from a list comprising the one or more data types, the at least one data type of the one or more data types of autonomous vehicle log data corresponding to the event.

8. The method of claim 7, wherein the metadata file further comprises an indication of the one or more data types of autonomous vehicle log data in the primary data file, and the list comprising the one or more data types is generated for display in the user interface based on the metadata file.

9. The method of claim 7, wherein the request is based on the selection, within the user interface, of the at least one data type of the one or more data types of autonomous vehicle log data.

10. The method of claim 1, wherein the request is based on a user selection, within the data visualization platform, of at least one visualization display type corresponding to the at least one data type of the one or more data types of autonomous vehicle log data.

11. The method of claim 1, wherein the request is based on a user selection, via a visualization display within the data visualization platform, of at least one playback position corresponding to the at least one temporal parameter.

12. The method of claim 1, wherein the at least one temporal parameter is based on a user selection, via a visualization display within the data visualization platform, of a play button.

13. The method of claim 1, wherein:
the at least one temporal parameter comprises a first temporal range and a second temporal range,
the first temporal range and the second temporal range each comprise at least one time interval of the one or more predefined time intervals, and
the first temporal range is immediately adjacent to the second temporal range.

14. The method of claim 13, wherein:
retrieving the one or more portions of the autonomous vehicle log data comprises retrieving a first portion based on the first temporal range and retrieving a second portion based on the second temporal range, and
transmitting the one or more portions of the autonomous vehicle log data comprises transmitting the first portion before transmitting the second portion.

15. The method of claim 1, wherein:
the at least one temporal parameter comprises a first temporal range and a second temporal range,
the first temporal range and the second temporal range each comprise at least one time interval of the one or more predefined time intervals, and
the first temporal range and the second temporal range are separated from one another by one or more other temporal ranges.

16. The method of claim 1, wherein the at least one temporal parameter comprises a temporal range extending from a start point of the event to an end point of the event, and retrieving the portion of the autonomous vehicle log data comprises retrieving all segments within the temporal range of the at least one grouping of the one or more groupings in the primary data file.

17. The method of claim 1, wherein generating the visualization within the data visualization platform based on the specified data types of the one or more data types of autonomous vehicle log data comprises updating the visualization as additional portions of the autonomous vehicle log data are transmitted to the data visualization platform.

18. The method of claim 1, wherein the primary data file and the metadata file are generated, and the one or more portions of the autonomous vehicle log data are retrieved, in a cloud computing environment at which the autonomous vehicle log data was received.

19. The method of claim 18, wherein the visualization is generated in a computing environment separate from the cloud computing environment.

20. A system for streaming log data of an autonomous vehicle for visualization, the system comprising one or more processors and memory storing instructions that, when executed by the one or more processors, cause the system to:
receive autonomous vehicle log data for an event associated with operation of the autonomous vehicle;
generate a primary data file for the event comprising one or more groupings of the autonomous vehicle log data, wherein each grouping of the one or more groupings corresponds to a particular data type of one or more data types of autonomous vehicle log data and each grouping of the one or more groupings is divided into one or more segments associated with one or more predefined time intervals;
generate a metadata file for the event comprising one or more timestamps and one or more data locations, wherein each timestamp and data location corresponds to a start point or an end point of one of the one or more segments in the primary data file;
receive a request specifying:
at least one data type of the one or more data types of autonomous vehicle log data to be streamed; and
at least one temporal parameter, wherein the at least one temporal parameter corresponds to at least one grouping of the one or more groupings in the primary data file;
retrieve one or more portions of the autonomous vehicle log data from the primary data file based on the request, the one or more timestamps in the metadata file, and the one or more data locations in the metadata file; and
transmit via a network communication interface the one or more portions of the autonomous vehicle log data to a data visualization platform to generate a visualization based on the specified data types of the one or more data types of autonomous vehicle log data.

21. A non-transitory computer readable storage medium storing instructions for streaming log data of an autonomous vehicle for visualization, wherein the instructions, when executed by one or more processors of an electronic device, cause the device to:
receive autonomous vehicle log data for an event associated with operation of the autonomous vehicle;
generate a primary data file for the event comprising one or more groupings of the autonomous vehicle log data, wherein each grouping of the one or more groupings corresponds to a particular data type of one or more data types of autonomous vehicle log data and each grouping of the one or more groupings is divided into one or more segments associated with one or more predefined time intervals;
generate a metadata file for the event comprising one or more timestamps and one or more data locations, wherein each timestamp and data location corresponds to a start point or an end point of one of the one or more segments in the primary data file;
receive a request specifying:
at least one data type of the one or more data types of autonomous vehicle log data to be streamed; and
at least one temporal parameter, wherein the at least one temporal parameter corresponds to at least one grouping of the one or more groupings in the primary data file;
retrieve one or more portions of the autonomous vehicle log data from the primary data file based on the request, the one or more timestamps in the metadata file, and the one or more data locations in the metadata file; and
transmit via a network communication interface the one or more portions of the autonomous vehicle log data to a data visualization platform to generate a visualization based on the specified data types of the one or more data types of autonomous vehicle log data.
